(19) United States
(12) Patent Application Publication
(10) Pub. No.: US 2025/0066594 A1
(43) Pub. Date: Feb. 27, 2025

(54) HIGH IMPACT POLYPROPYLENE COMPOSITION

(71) Applicant: SABIC GLOBAL TECHNOLOGIES B.V., Bergen op Zoom (NL)

(72) Inventors: Marc HERKLOTS, Geleen (NL); Ginger DE LA CROIX, Hoensbroek (NL); Sarah VAN MIERLOO, Opglabbeek (BE)

(21) Appl. No.: 18/722,651

(22) PCT Filed: Dec. 16, 2022
(86) PCT No.: PCT/EP2022/086443

§ 371 Date: Jun. 21, 2024

(30) Foreign Application Priority Data
Dec. 21, 2021 (EP) 21216524.5

(51) Int. Cl. C08L 23/14; C08K 5/00

(52) U.S. Cl. CPC C08L 23/142; C08K 5/0083; C08L 2205/025; C08L 2207/02; C08L 2207/066; C08L 2314/02

(57) ABSTRACT

A polypropylene composition includes at least 85 wt % a heterophasic propylene copolymer (A), 1.0 to 7.0 wt % a low density polyethylene (B), and 0.001 to 1.5 wt % an α-nucleating agent (C), wherein the heterophasic propylene copolymer (A) includes 75 to 90 wt % (a) a propylene homopolymer matrix and 10 to 25 wt % (b) an and wherein the ethylene-propylene copolymer comprises 43 to 57 wt % of units derived from ethylene and wherein the low density polyethylene (B) has a melt flow rate (MFR_{LDPE, 230}) using 2.16 kg at 230° C. and wherein the low density polyethylene (B) has a density of 915 to 932 kg/m³, wherein the polypropylene composition has a total melt flow rate (MFRₜₒₜₐₗ) of 30 to 150 dg/min, wherein the total melt flow rate is determined using ISO1133:2011 using 2.16 kg at 230° C., wherein the polypropylene composition satisfies the following inequation: 0.9<MFRₜₒₜₐₗ/MFR_{LDPE, 230}<150.

### CROSS REFERENCE TO RELATED APPLICATIONS

This application is a National Stage application of PCT/EP2022/086443, filed Dec. 16, 2022, which claims the benefit of European Application No. 21216524.5, filed Dec. 21, 2021, both of which are incorporated by reference in their entirety herein.

### BACKGROUND

The invention relates to a polypropylene composition, to an article comprising such composition, to a process for the preparation of said composition, to a process for the preparation of said article, to the use of said polypropylene composition for the preparation of an article, preferably an injection molded article and to the use of said polypropylene composition for increasing the impact strength at −20° C.

Thin-walled packaging is desirable from a downgauging perspective, as the use of thin-walls allows for the use of as little material as possible. However, for thin-wall packaging, it is also very important to have a well flowing material having good mechanical properties, that is having a high tensile modulus and a good impact strength. A good flowability is needed for achieving a good processability of the material in the various processes for the preparation of articles, such as injection molding processes. A good processability allows for the high production speed required in the mass production of the articles and leads to lower energy and processing costs. The mechanical properties of the thin-walled articles are very important. Especially for containers, there is a need that they contain the content contained therein, such as good. In addition, the containers should have sufficient stiffness, so that they can be stacked for storage or transportation. Finally, the thin-walled articles should also be able to withstand mechanical impact damage, inflicted by frequently occurring events, such as dropping of the articles.

There is a continuous desire to improve such thin-wall packaging (e.g. food packaging) to improve the impact properties while at the same time maintaining the other properties, such as good processability and stiffness. For example, for chilled and frozen food packaging (e.g. icecream tubs), the food packaging should have a good impact both at low temperature—so that if the package is taken from the freezer and accidentally dropped it does not break and spill its contents—and at room temperature, so that the package also does not break once the package is at room temperature.

### SUMMARY

It is the object of the invention to provide a polypropylene composition which is suitable for the preparation of thin wall injection molded articles, which has good impact properties at low temperature (e.g. −20° C.) as well as at room temperature (e.g. 23° C.).

This object is achieved by a polypropylene composition comprising
a heterophasic propylene copolymer (A) in an amount of at least 85 wt % based on the polypropylene composition
a low density polyethylene (B) in an amount from 1.0 to 7.0 wt % based on the polypropylene composition
and an α-nucleating agent (C) in an amount from 0.001 to 1.5 wt % based on the polypropylene composition
wherein the heterophasic propylene copolymer (A) comprises
(a) a propylene homopolymer matrix in an amount from 75 to 90 wt % based on the heterophasic propylene copolymer and
(b) an ethylene-propylene copolymer in an amount from 10 to 25 wt % based on the heterophasic propylene copolymer and wherein the ethylene-propylene copolymer comprises 43 to 57 wt % of units derived from ethylene and
wherein the low density polyethylene (B) has a melt flow rate (MFR_{LDPE, 230}) as determined according to ISO1133:2011 using 2.16 kg at 230° C.
and wherein the low density polyethylene (B) has a density in the range from 915 to 932 kg/m³ as measured according to ISO1183-1:2012
wherein the polypropylene composition has a total melt flow rate (MFRₜₒₜₐₗ) in the range from 30 to 150 dg/min, wherein the total melt flow rate is determined using ISO1133:2011 using 2.16 kg at 230° C.,
wherein the polypropylene composition satisfies the following inequation:

$$0.9 < {MFR}_{total} / {MFR}_{LDPE , 230} < 150$$

It was found that with the polypropylene composition of the invention, the impact properties at low temperature as well as at room temperature are increased while the stiffness and processability are maintained.

### DETAILED DESCRIPTION

### Low Density Polyethylene (B)

In the polypropylene composition of the invention, the low density polyethylene (B) is present in an amount from 1.0 to 7.0 wt %, preferably in an amount from 2.0 to 6.0 wt %, for example in an amount from 2.5 to 5.5 wt % or for example in an amount from 1.0 to 5.0 wt % based on the polypropylene composition.

The low density polyethylene (LDPE) has a density in the range from 915 to 932 kg/m³ as measured according to ISO1872-2:2007. More preferably, the LDPE has a density in the range from 915 to 928 kg/m³, most preferably in the range from 918 to 922 kg/m³ as measured according to ISO1183-1:2012 at 23° C.

Preferably, the low density polyethylene has a melt flow rate (MFR_{LDPE, 230}) as determined according to ISO1133:2011 using 2.16 kg at 230° C. in the range from 0.30 to 20 dg/min, preferably in the range from 1.0 to 15, more preferably in the range from 1.5 to 10 dg/min.

Therefore, the invention also relates to a polypropylene composition of the invention, wherein the low density polyethylene (B)
i) has a melt flow rate (MFR_{LDPE, 230}) as determined according to ISO1133:2011 using 2.16 kg at 230° C. in the range from 0.30 to 20 dg/min and/or
ii) has a density in the range from 915 to 928, preferably in the range from 918 to 922 kg/m³ as measured according to ISO1183-1:2012.

Preferably, the low density polyethylene (B) has a melt flow rate as determined according to ISO1133:2011 using 2.16 kg at 190° C. (MFR_{LDPE, 190}) in the range from 0.10 to 5.0 dg/min, preferably in the range from 0.20 to 3.8 dg/min.

LDPE applied in the polypropylene composition of the invention may be produced by use of autoclave high pressure technology or by tubular reactor technology. An example of a suitable LDPE is the commercially available SABIC® LDPE 2201H0.

### Polypropylene Composition

The polypropylene composition has a total melt flow rate as determined using ISO1133:2011 using 2.16 kg at 230° C. in the range from 1.0 to 150 dg/min, preferably in the range from 20 to 120 dg/min, more preferably in the range from 40 to 100 dg/min.

The polypropylene composition may for example be prepared in a process comprising the step of
a) melt-mixing the heterophasic propylene copolymer (A), the low density polyethylene (B) and the α-nucleating agent (C) and optional additives (D). Melt-mixing may be performed in a manner known per se, for example in an extruder.

### Additives (D)

The composition of the invention may further comprise additives (D).

Examples of suitable additives (D) include but are not limited to UV stabilizers, hindered amine stabilizers (HALS), process stabilisers such as phosphites, (phenolic) antioxidants, acid scavengers, lubricants, processing aids and pigments.

Additives may for example be present in the composition of the invention in an amount from 0.10 to 1.0 wt % based on the heterophasic propylene copolymer composition.

Preferably, the additives (D) are present in an amount 0.10 to 1.0 wt % based on the polypropylene composition.

For the avoidance of doubt, the additives (D) as defined herein do not include an α-nucleating agent.

### α-Nucleating Agent

Suitable α-nucleating agents are known to the skilled person. Examples of suitable α-nucleating agents include but are not limited to α-nucleating agents selected from the group consisting of:
(i) salts of monocarboxylic acids and polycarboxylic acids, e.g. sodium benzoate or aluminum tert-butylbenzoate; calcium salt of hexahydrophthalic acid or a dicarboxylate salts, for example Hyperform® HPN20E as commercially available from Milliken;
(ii) soluble nucleating agents, like sorbitol derivatives, e.g. di(alkylbenzylidene) sorbitols as 1,3:2,4-25 dibenzylidene sorbitol, 1,3:2,4-di(4-methylbenzylidene) sorbitol, 1,3:2,4-di(4-ethylbenzylidene) sorbitol and 1,3:2,4-Bis(3,4-dimethylbenzylidene) sorbitol, as well as nonitol derivatives, e.g. 1,2,3-trideoxy-4,6;5,7-bis-O-[(4-propylphenyl)methylene] nonitol, and benzenetrisamides like substituted 1,3,5-benzenetrisamides as N,N′,N″-tris-tert-butyl-1,3,5-benzenetricarboxamide, N,N′,N″-tris-cyclohexyl-1,3,5-benzene-tricarboxamide and N-[3,5-bis-(2,2-dimethyl-propionylamino)-phenyl]-2,2-dimethyl-propionamide, wherein 1,3:2,4-di(4-methylbenzylidene) sorbitol and N-[3,5-bis-(2,2-dimethyl-propionylamino)-phenyl]-2,2-dimethyl-propionamide are equally preferred,
(iii) salts of diesters of phosphoric acid, e.g. sodium 2,2′-methylenebis (4,6,-di-tert-butylphenyl) phosphate or aluminium-hydroxy-bis [2,2′-methylene-bis(4,6-di-t-butylphenyl) phosphate], and hydroxybis (2,4,8,10-tetra-tert-butyl-6-hydroxy-12Hdibenzo(d,g)(1,3,2) dioxaphosphocin 6-oxidato) aluminium, wherein hydroxybis (2,4,8,10-tetra-tert-butyl-6-hydroxy-12H-dibenzo(d,g) (1,3,2) dioxaphosphocin 6-oxidato) aluminium is preferred;
(iv) polymeric nucleating agents, such as polymerised vinyl compounds, in particular vinyl cycloalkanes, like vinyl cyclohexane (VCH), poly(vinyl cyclohexane) (PVCH), vinylcyclopentane, and vinyl-2-methyl cyclohexane, 3-methyl-1-butene, 3-ethyl-1-hexene, 3-methyl-1-pentene, 4-methyl-1-pentene or mixtures thereof. PVCH is a particularly preferred; and
(v) talcums.

Talc is a relatively abundant, inexpensive, highly hydrophobic and generally unreactive mineral. It can be categorized as a hydrated magnesium silicate and its main components can be represented by, inter alia, one or more of the formulas (Si₂O₅)₂Mg₃(OH)₂, Si₈Mg₆O₂₀(OH)₄ or Mg₁₂Si₁₆O₄₀ (OH)₈. Talcs suitable for use as additives to a heterophasic propylene copolymer are commercially available from for example Imerys Luzenac. ‘Talc’ and ‘talcum’ are used interchangeably herein.

Polymeric nucleating agents from group (iv) can either be incorporated by in-reactor nucleation or by the so called Masterbatch technology (compounding technology).

Preferably, the α-nucleating agent is selected from the group consisting of (i) salts of monocarboxylic acids and polycarboxylic acids, (ii) sorbitol or nonitol derivatives, benzenetrisamides, (iii) salts of diesters of phosphoric acid, (iv) polymeric nucleating agents and (v) talcums, more preferably, the α-nucleating agent is selected from the group consisting of (i) salts of monocarboxylic acids and polycarboxylic acids and (v) talcums.

The α-nucleating agent is present in an amount from 0.001 to 1.5 wt %, preferably in an amount of 0.010 to 1.2 wt % based on the polypropylene composition.

Preferably, the sum of the amount of heterophasic propylene copolymer (A), the low density polyethylene (B), the α-nucleating agent (C) and the optional additives (D) is 100 wt % based on the polypropylene composition.

The polypropylene composition satisfies the following inequation:

$$0.9 < {MFR}_{total} / {MFR}_{LDPE , 230} < 150 ,$$

preferably the polypropylene composition satisfies the following inequation:

$$0.9 < {MFR}_{total} / {MFR}_{LDPE , 230} < 130$$

preferably the polypropylene composition satisfies the following inequation:

$$0.9 < {MFR}_{total} / {MFR}_{LDPE , 230} < 100$$

wherein MFRₜₒₜₐₗ stands for the melt flow rate of the polypropylene composition as determined using ISO1133:2011 using 2.16 kg at 230° C. and wherein MFR_{LDPE, 230} stands for the melt flow rate of the low density polyethylene (B) as determined according to ISO1133:2011 using 2.16 kg at 230° C.

Preferably, the polypropylene composition also satisfies the following inequation:

$$1. < {MFR}_{total} / {MFR}_{LDPE , 190} < 95$$

more preferably, the polypropylene composition satisfies the following inequation

$$1. < {MFR}_{total} / {MFR}_{LDPE , 190} < 85 ,$$

wherein MFRₜₒₜₐₗ stands for the melt flow rate of the polypropylene composition as determined using ISO1133:2011 using 2.16 kg at 230° C. and wherein MFR_{LDPE, 190} stands for the melt flow rate of the low density polyethylene (B) as determined according to ISO1133:2011 using 2.16 kg at 190° C.

### Heterophasic Propylene Copolymer (A)

Preferably, the heterophasic propylene copolymer (A) is present in an amount of at least 85 wt % based on the polypropylene composition, for example in an amount of at least 86 wt %, of at least 87 wt %, of at least 88 wt %, of at least 89 wt %, of at least 90 wt %, of at least 91 wt %, of at least 92 wt %, of at least 93 wt %, of at least 94 wt % or of at least 95 wt % based on the polypropylene composition.

The heterophasic propylene copolymer (A) comprises
(a) a propylene homopolymer matrix in an amount from 75 to 90 wt % based on the heterophasic propylene copolymer and
(b) an ethylene-propylene copolymer in an amount from 10 to 25 wt % based on the heterophasic propylene copolymer and wherein the ethylene-propylene copolymer comprises 43 to 57 wt % of units derived from ethylene.

Preferably, the heterophasic propylene copolymer has a melt flow rate (MFR_{HECO}) as determined according to ISO1133:2011 using 2.16 kg at 230° C. in the range from 1.0 to 150 dg/min, preferably in the range from 20 to 120 dg/min, more preferably in the range from 40 to 100 dg/min.

Preferably, the heterophasic propylene copolymer has a total ethylene content in the range from 3.0 to 15 wt %, preferably in the range from 5.0 to 14 wt %, based on the heterophasic propylene copolymer.

Preferably, the heterophasic propylene copolymer has an Mw/Mn in the range from 3.0 to 11.0, more preferably in the range from 4.0 to 9.0, wherein Mw stands for the weight average molecular weight and Mn stands for the number average weight and wherein Mw and Mn are measured according to ISO16014-1(4):2003.

Preferably, the invention relates to the polypropylene composition of the invention, wherein the heterophasic propylene copolymer
i) has a melt flow rate (MFR_{HECO}) as determined according to ISO1133:2011 using 2.16 kg at 230° C. in the range from 1.0 to 150 dg/min, preferably in the range from 20 to 120 dg/min, more preferably in the range from 40 to 100 dg/min and/or
ii) has a total ethylene content in the range from 3.0 to 15 wt %, preferably in the range from 5.0 to 14 wt %, based on the heterophasic propylene copolymer and/or
iii) has an Mw/Mn in the range from 3.0 to 11.0, wherein Mw stands for the weight average molecular weight and Mn stands for the number average weight and wherein Mw and Mn are measured according to ISO16014-1(4):2003.

### Ethylene-Propylene Copolymer

In one embodiment of the invention, the heterophasic propylene copolymer comprises the ethylene-propylene copolymer in an amount of 10 to 15 wt % based on the heterophasic propylene copolymer and the ethylene-propylene copolymer comprises 43 to 51 wt % of units derived from ethylene.

In another embodiment of the invention, the heterophasic propylene copolymer comprises the ethylene-propylene copolymer in an amount of 20 to 25 wt % based on the heterophasic propylene copolymer and the ethylene-propylene copolymer comprises 52 to 57 wt % of units derived from ethylene.

Preferably, the melt flow rate of the ethylene-propylene copolymer (MFI_{rubber}) is in the range from 0.03 to 3.0 dg/min, preferably in the range from 0.04 to 2.5 dg/min, for example in the range from 0.05 to 2.0 dg/min, wherein the MFI_{rubber} is calculated according to the following formula:

MFI_{rubber}=10\hat{ }((Log MFIheterophasic−matrix content*Log MFImatrix)/(rubber content))

wherein
MFIheterophasic is the MFR (dg/min) of the heterophasic propylene copolymer measured according to ISO1133-1:2011 (2.16 kg/230° C.),
MFImatrix is the MFR (dg/min) of the propylene-based matrix measured according to ISO1133-1:2011 (2.16 kg/230° C.),
matrix content is the fraction of the propylene-based matrix in the heterophasic propylene copolymer,
rubber content is the fraction of the dispersed ethylene-α-olefin copolymer in the heterophasic propylene copolymer. For the avoidance of any doubt, Log in the formula means log 10.

The xylene soluble content (CXS) of the heterophasic propylene copolymer (A) is preferably in the range from 10 to 25 wt %, wherein the xylene soluble content is measured in accordance with ISO 16152:2005 in p-xylene at 25° C.

The intrinsic viscosity of the CXS (IV_{CXS}) of the heterophasic propylene copolymer (A) is preferably in the range from 1.0 to 6.0 dl/g, more preferably in the range from 1.8 to 5.0 dl/g, even more preferably in the range from 2.0 to 4.0 dl/g wherein the intrinsic viscosity is determined on the CXS measured in accordance with ISO 16152:2005 in p-xylene at 25° C. using ISO1628-1 and -3 in decalin at 135° C.

### Process for the Preparation of the Heterophasic Propylene Copolymer (A)

Heterophasic propylene copolymers are generally prepared in one or more reactors, by polymerization of propylene in the presence of a catalyst and subsequent polymerization of ethylene with α-olefins. The resulting polymeric materials are heterophasic, but the specific morphology usually depends on the preparation method and monomer ratios used.

The heterophasic propylene copolymers employed in the process according to present invention can be produced using any conventional technique known to the skilled person, for example a multistage process polymerization, such as bulk polymerization, gas phase polymerization, slurry polymerization, solution polymerization or any combinations thereof. Any conventional catalyst systems, for example, Ziegler-Natta or metallocene may be used. Such techniques and catalysts are described, for example, in WO06/010414; Polypropylene and other Polyolefins, by Ser van der Ven, Studies in Polymer Science 7, Elsevier 1990; WO06/010414, U.S. Pat. Nos. 4,399,054 and 4,472,524. Preferably, the heterophasic propylene copolymer is made using Ziegler-Natta catalyst.

The heterophasic propylene copolymer may be prepared by a process comprising
polymerizing propylene in the presence of a catalyst system to obtain the propylene-based matrix and
subsequently polymerizing ethylene with α-olefins in the presence of a catalyst system in the propylene-based matrix to obtain the heterophasic propylene copolymer consisting of a propylene-based matrix and a dispersed phase. These steps are preferably performed in different reactors. The catalyst systems for the first step and for the second step may be different or same.

### Catalyst System

Ziegler-Natta catalyst systems are well known in the art. The term normally refers to catalyst systems comprising a transition metal containing solid catalyst compound (procatalyst) and an organo-metal compound (co-catalyst). Optionally one or more electron donor compounds (external donor) may be added to the catalyst system as well.

The transition metal in the transition metal containing solid catalyst compound is normally chosen from groups 4-6 of the Periodic Table of the Elements (Newest IUPAC notation); more preferably, the transition metal is chosen from group 4; the greatest preference is given to titanium (Ti) as transition metal.

Although various transition metals are applicable, the following is focused on the most preferred one being titanium. It is, however, equally applicable to the situation where other transition metals than Ti are used. Titanium containing compounds useful in the present invention as transition metal compound generally are supported on hydrocarbon-insoluble, magnesium and/or an inorganic oxide, for instance silicon oxide or aluminum oxide, containing supports, generally in combination with an internal electron donor compound. The transition metal containing solid catalyst compounds may be formed for instance by reacting a titanium (IV) halide, an organic internal electron donor compound and a magnesium and/or silicon containing support. The transition metal containing solid catalyst compounds may be further treated or modified with an additional electron donor or Lewis acid species and/or may be subjected to one or more washing procedures, as is well known in the art.

Some examples of Ziegler-Natta (pro) catalysts and their preparation method which can suitably be used to prepare the heterophasic propylene copolymer (A) can be found in EP 1 273 595, EP 0 019 330, U.S. Pat. No. 5,093,415, Example 2 of U.S. Pat. Nos. 6,825,146, 4,771,024 column 10, line 61 to column 11, line 9, WO03/068828, U.S. Pat. No. 4,866,022, WO96/32426A, example I of WO 2007/134851 A1 and in WO2015/091983 all of which are hereby incorporated by reference.

The (pro) catalyst thus prepared can be used in polymerization of the heterophasic propylene copolymer using an external donor, for example as exemplified herein, and a co-catalyst, for example as exemplified herein.

In one embodiment, the heterophasic propylene copolymer is made using a catalyst which is free of phthalate.

It is preferred to use so-called phthalate free internal donors because of increasingly stricter government regulations about the maximum phthalate content of polymers. In the context of the present invention, “essentially phthalate-free” or “phthalate-free” means having a phthalate content of less than for example 150 ppm, alternatively less than for example 100 ppm, alternatively less than for example 50 ppm, alternatively for example less than 20 ppm, for example of 0 ppm based on the total weight of the catalyst. Examples of phthalates include but are not limited to a dialkylphthalate esters in which the alkyl group contains from about two to about ten carbon atoms. Examples of phthalate esters include but are not limited to diisobutylphthalate, ethylbutylphthalate, diethylphthalate, di-n-butylphthalate, bis(2-ethylhexyl) phthalate, and diisodecylphthalate.

Examples of phthalate free internal donors include but are not limited to 1,3-diethers, for example 9,9-bis(methoxymethyl) fluorene, optionally substituted malonates, maleates, succinates, glutarates, benzoic acid esters, cyclohexene-1,2-dicarboxylates, benzoates, citraconates, aminobenzoates, silyl esters and derivatives and/or mixtures thereof.

The catalyst system comprising the Ziegler-Natta pro-catalyst may be activated with an activator, for example an activator chosen from the group of benzamides and monoesters, such as alkylbenzoates.

The catalyst system includes a co-catalyst. As used herein, a “co-catalyst” is a term well-known in the art in the field of Ziegler-Natta catalysts and is recognized to be a substance capable of converting the procatalyst to an active polymerization catalyst. Generally, the co-catalyst is an organometallic compound containing a metal from group 1, 2, 12 or 13 of the Periodic System of the Elements (Handbook of Chemistry and Physics, 70th Edition, CRC Press, 1989-1990). The co-catalyst may include any compounds known in the art to be used as “co-catalysts”, such as hydrides, alkyls, or aryls of aluminum, lithium, zinc, tin, cadmium, beryllium, magnesium, and combinations thereof. The co-catalyst may be a hydrocarbyl aluminum co-catalyst as are known to the skilled person. Preferably, the cocatalyst is selected from trimethylaluminium, triethylaluminum, triisobutylaluminum, trihexylaluminum, di-isobutylaluminum hydride, trioctylaluminium, dihexylaluminum hydride and mixtures thereof, most preferably, the cocatalyst is triethylaluminium (abbreviated as TEAL).

Examples of external donors are known to the person skilled in the art and include but are not limited to external electron donors chosen from the group of compounds having a structure according to Formula III (R⁹⁰)₂N—Si(OR⁹¹)₃, compounds having a structure according to Formula IV: (R⁹²) Si(OR⁹³)₃ and mixtures thereof, wherein each of R⁹⁰, R⁹¹ , R⁹² and R⁹³ groups are each independently a linear, branched or cyclic, substituted or unsubstituted alkyl having from 1 to 10 carbon atoms, preferably wherein R⁹⁰, R⁹¹, R⁹² and R⁹³ groups are each independently a linear unsubstituted alkyl having from 1 to 8 carbon atoms, for example ethyl, methyl or n-propyl, for example diethylaminotriethoxysilane (DEATES), n-propyl triethoxysilane, (nPTES), n-propyl trimethoxysilane (nPTMS); and organosilicon compounds having general formula Si(OR^{a})₄₋ₙR^{b}ₙ, wherein n can be from 0 up to 2, and each of R^{a} and R^{b}, independently, represents an alkyl or aryl group, optionally containing one or more hetero atoms for instance O, N, S or P, with, for instance, 1-20 carbon atoms; such as diisobutyl dimethoxysilane (DiBDMS), t-butyl isopropyl dimethyxysilane (tBuPDMS), cyclohexyl methyldimethoxysilane (CHMDMS), dicyclopentyl dimethoxysilane (DCPDMS) or di(iso-propyl) dimethoxysilane (DiPDMS). More preferably, the external electron donor is chosen from the group of di(iso-propyl) dimethoxysilane (DiPDMS) or diisobutyl dimethoxysilane (DiBDMS).

Preferably, the heterophasic propylene copolymer is produced in a sequential multi-reactor polymerization process, for example in a gas-phase process, in the presence of
a) a Ziegler-Natta catalyst comprising compounds of a transition metal of Group 4 to 6 of IUPAC, a Group 2 metal compound and an internal donor, wherein said internal donor preferably is a non-phthalic compound, more preferably a non-phthalic acid ester, even more preferably wherein said internal donor is selected from the group of 1,3-diethers, for example 9,9-bis(methoxymethyl) fluorene, optionally substituted malonates, maleates, succinates, glutarates, benzoic acid esters, cyclohexene-1,2-dicarboxylates, benzoates, citraconates, aminobenzoates, silyl esters and derivatives and/or mixtures;
b) a co-catalyst (Co), and
c) optionally an external donor.

The heterophasic propylene copolymer having a melt flow rate (MFR_{HECO}) as determined according to ISO1133:2011 using 2.16 kg at 230° C. in the range from 10 to 150 dg/min, preferably in the range from 15 to 135 dg/min may be obtained directly from the reactor(s), but may also be prepared by visbreaking an intermediate heterophasic propylene copolymer prepared in a sequential multi-reactor polymerization process and having an initial melt flow rate (MFRᵢ) as determined according to ISO1133:2011 using 2.16 kg at 230° C. by contacting said intermediate heterophasic propylene copolymer in a melt mixing process with a peroxide to form the heterophasic propylene copolymer having a melt flow rate (MFR_{HECO}) as determined according to ISO1133:2011 using 2.16 kg at 230° C. with a visbreaking ratio MFR_{HECO}/MFRᵢ in the range from 1.2 to 10.

### Propylene Homopolymer Matrix

The heterophasic propylene copolymer (A) comprises a propylene homopolymer matrix in an amount from 75 to 90 wt %, preferably in an amount from based on the heterophasic propylene copolymer.

Preferably, the propylene homopolymer matrix i) has a pentad isotacticity of at least 95 wt. %, preferably of at least 96 wt % wherein the isotacticity is determined using 13C NMR.

Preferably, the propylene homopolymer has a melt flow rate (MFR_{PP}) as determined according to ISO1133:2011 using 2.16 kg at 230° C. in the range from 35 to 150 dg/min, preferably in the range from 40 to 150 dg/min.

Preferably, the propylene homopolymer has a molecular weight distribution (Mw/Mn), in the range from 1.0 to 11.0, more preferably in the range from 4.0 to 9.0, wherein Mw stands for the weight average molecular weight and Mn stands for the number average weight and wherein Mw and Mn are measured according to ISO16014-1(4):2003.

The invention therefore also relates to a polypropylene composition according to the invention, a wherein the propylene homopolymer matrix
i) has a pentad isotacticity of at least 95 wt. %, preferably of at least 96 wt % and preferably at most 99 wt %, preferably in the range from at least 95 wt % to at most 99 wt %, wherein the pentad isotacticity is determined using 13C NMR and/or
ii) has a melt flow rate (MFR_{PP}) as determined according to ISO1133:2011 using 2.16 kg at 230° C. in the range from 35 to 150 dg/min, preferably in the range from 40 to 150 dg/min and/or
iii) has an Mw/Mn in the range from 1.0 to 11.0, wherein Mw stands for the weight average molecular weight and Mn stands for the number average weight and wherein Mw and Mn are measured according to ISO16014-1(4):2003.

The invention also relates to a polypropylene composition according to the invention, wherein the polypropylene composition when injection molded into a 3.2 mm thick specimen prepared according to ISO37/2 shows a maximal agglomerate size of ≤50 μm, preferably ≤30 μm, more preferably ≤10 μm, most preferably of 0 μm (no agglomerates).

In another aspect, the invention relates to an article comprising the polypropylene composition of the invention. Preferably in said article, the amount of the polypropylene composition is at least 95 wt % based on the article, more preferably at least 96 wt %, more preferably at least 97 wt %, even more preferably at least 98 wt %, most preferably at least 99 wt %. The article may also consist of the polypropylene composition of the invention.

The article can be prepared using commonly known techniques such as film extrusion, sheet extrusion, cast film processes, injection molding and/or thermoforming, preferably the article is prepared by injection molding.

The article can suitably be used as a packaging article, for example a food packaging article.

Therefore, the invention also relates to an article comprising the polypropylene composition according to any one of the preceding claims, preferably wherein the amount of the polypropylene composition is at least 95 wt % based on the article and/or wherein the article is prepared by injection molding and/or wherein the article is a packaging article, preferably a food packaging article.

In another aspect, the invention relates to the use of the polypropylene composition of the invention for the preparation of an article, preferably wherein the article is prepared by injection molding and/or wherein the article is a packaging article, preferably a food packaging article.

In another aspect, the invention relates to a process for the preparation of an article comprising the steps of
a) providing the polypropylene composition of the invention and
b) converting the polypropylene composition into an article, for example by using an extrusion or injection molding process.

In another aspect, the invention relates to the use the polypropylene composition of the invention for preparing articles with an increased impact strength at −20° C., wherein the impact strength is determined in perpendicular direction using ISO 180 4 A on an injection moulded test specimen with test geometry 65*12.7*3.2 mm and using a 45° notch in accordance with ISO37/2.

It is noted that the invention relates to the subject-matter defined in the independent claims alone or in combination with any possible combinations of features described herein, preferred in particular are those combinations of features that are present in the claims. It will therefore be appreciated that all combinations of features relating to the compositions according to the invention; all combinations of features relating to the processes according to the invention and all combinations of features relating to the compositions according to the invention and features relating to the processes according to the invention are described herein.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process.

The invention is now elucidated by way of the following examples, without however being limited thereto.

### Examples

### Measurements

### Amount of Propylene-Based Matrix and Dispersed Ethylene α-Olefin Copolymer ¹³C NMR:

The amount of the propylene-based matrix, the amount of ethylene incorporated into the dispersed ethylene-α-olefin copolymer (also referred to herein as ‘rubber phase’) (RCC2) and the dispersed ethylene-α-olefin copolymer (RC) were determined by ¹³C-NMR spectroscopy.

To this end, approximately 150 mg of material was dissolved in 1,1,2,2-tetrachloroethane-d2 (TCE-d2). To ensure a homogeneous solution, the sample preparation has been conducted in a heated rotary oven. The NMR measurements were carried out in the solution-state using a Bruker 500 Advance III HD spectrometer operating at 500.16 and 125.78 MHz for 1H and 13C, respectively, and equipped with a 10 mm DUAL cryogenically-cooled probe head operating at 125° C. The 13C-NMR experiments were performed using standard single pulse excitation utilizing the NOE and bi-level WALTZ16 decoupling scheme (Zhou Z. et al. J. Mag. Reson 187 (2007) 225. A total of 512 transients were acquired per spectrum. The spectra were calibrated by setting the central signal of TCE's triplet at 74.2 ppm. Quantitative 13C NMR spectra were processed, integrated and relevant quantitative properties determined from the integrals using proprietary computer programs.

### Isotacticity ¹³C NMR

175 mg of the polypropylene granules was dissolved in 3 ml at 130° C. in deuterated tetrachloroethylene (C2D2CI4) containing 2,6-Di-tert-butyl-4-methylphenol (BHT) (5 mg BHT in 200 ml C2D2CL). The 13C NMR spectrum was recorded on a Bruker Avance 500 spectrometer equipped with a cryogenically cooled probe head operating at 125° C. The isotacticity of the mmmm pentad levels was determined from the ¹³C NMR spectrum in % based on the total pentad amount.

### GPC/SEC

The number average molecular weight (Mn), the weight average molecular weight (Mw) and the Z average molecular weight (Mz) were determined using ISO16014-1(4):2003. SEC-DV was used with universal calibration. SEC measurements were performed on a PolymerChar GPC system. The samples were dissolved in 1,2,4-trichlorobenzene (TCB) stabilized with 1 g/L butylhydroxytoluene (BHT) at concentrations of 0.3-1.3 mg/mL for 4 hours at 160° C. 300 μL of polymer solution was injected and the mobile phase flow rate was 1.0 ml/min. Infrared detection IR5 MCT and a differential viscometer were used. For setting up the universal calibration line polyethylene standards were used.

Flexural modulus (flexural stiffness, Flexural II) was determined according to ASTM D790-10 on 3.2 mm thick specimens prepared according to ISO37/2, in the parallel orientation.

Impact strength (Izod impact) was determined by measuring the Izod impact strength at −20° C., at 0° and at 23° C. according to ISO 180 4A, Test geometry: 65*12.7*3.2 mm, notch 45° according to ISO 37/2 perpendicular orientation.

The melt flow rate (MFR) was determined at 230° C. (for polypropylene) or at 190° C. or at 230° C. (for polyethylene) and 2.16 kg according to ISO1133:2011.

The melt flow rate (MFR) of the heterophasic propylene copolymer was determined at 230° C. and 2.16 kg according to ISO 1133:2011.

The MFI_{rubber} was calculated according to the following formula:

MFIrubber=10\hat{ }(Log MFIheterophasic−matrix content*Log MFImatrix)/rubber content

wherein
MFIheterophasic is the MFR (dg/min) of the heterophasic propylene copolymer measured according to ISO1133-1:2011 (2.16 kg/230° C.),
MFImatrix is the MFR (dg/min) of the propylene-based matrix measured according to ISO1133-1:2011 (2.16 kg/230° C.),
matrix content is the fraction of the propylene-based matrix in the heterophasic propylene copolymer,
rubber content is the fraction of the dispersed ethylene-α-olefin copolymer in the heterophasic propylene copolymer. For the avoidance of any doubt, Log in the formula means log 10.

With fraction is meant the amount as compared to 1, so for example if the propylene-based matrix is present in an amount of 89 wt % based on the heterophasic propylene copolymer, the matrix content is 0.89.

MFR total/MFR LDPE 190° C. or MFR total/MFR LDPE 230° C. ratio was determined by dividing the MFR of the total polypropylene composition by the MFR of the LDPE measured at 190° C. respectively 230° C.

### Gel Content Determination

The gel content was determined via on-line measurement of the film in a cast film system using an Optical Control System on line scan camera FS-3, equipped with software OCS Filmtest FS-3, (version 3.59a), wherein an optical film surface analyser is positioned between the chill roll system and the nip rolls. The surface analyser comprised a CCD line scan camera with a resolution of 50×75 μm. A film sample with a total surface size of 6.0 m² was tested.

### Agglomerate Size Determination

For the determining the size of LDPE agglomerates, an injection moulded plaque (3.2 mm thick specimens prepared according to ISO37/2) was cut in the length direction parallel to the machine direction. Cross-sections were made with cryo-microtomy (RM2265, diamond knife at −100° C. using liquid nitrogen). To determine the agglomerate size, the cross section was investigated with laser profilometry (Keyence VK-200) in the bulk, magnifications of 100× were applied.

### CXS

The amount of the xylene-soluble matter (CXS) of the powder (HECO 1 or HECO 2) was determined according to ISO 16152:2005 in p-xylene at 25° C. 1 gram of the powder and 100 ml of xylene were introduced in a glass flask equipped with a magnetical stirrer. The temperature was raised up to the boiling point of the solvent. The so obtained clear solution was then kept under reflux and stirring for further 15 minutes. Heating was stopped and the isolating plate between heating and flask was removed. The solution was then allowed to cool under stirring for 5 minutes. The closed flask was then kept for 30 min in a thermostatic water bath at 25° C. for 30 min. The formed solid was filtered on filtering paper. 25 ml of the filtered liquid was then poured in a previous weighed aluminium container. Subsequently, the container was heated in a stove of 140° C. for 2 hours, under nitrogen flow and vacuum, to remove the solvent by evaporation. The container was then kept in an oven at 140° C. under vacuum until constant weight was obtained. The weight percentage of polymer soluble in xylene at room temperature was then calculated.

The intrinsic viscosity of the xylene-soluble matter (IV_{CXS}) was determined according to ISO-1628-1 and -3 in decalin at 135° C. based on the CXS as determined as described above.

### Materials Used:

LDPE: SABIC® LDPE2100N0: commercially available low density polyethylene grade, having a melt flow index of 0.33 dg/min as determined at 190° C. and 2.16 kg according to ISO 1133:2011 and having a density of 921 kg/m³ as determined according to ISO1183-1:2012 at 23° C.
LDPE: SABIC® LDPE2200H0: commercially available low density polyethylene grade, having a melt flow index of 0.33 dg/min as determined at 190° C. and 2.16 kg according to ISO 1133:2011 and having a density of 922 kg/m³ as determined according to ISO1183-1:2012 at 23° C.
LDPE: SABIC® LDPE2201H0: commercially available low density polyethylene grade, having a melt flow index of 0.85 dg/min as determined at 190° C. and 2.16 kg according to ISO 1133:2011 and having a density of 922 kg/m³ as determined according to ISO1183-1:2012 at 23° C.
LDPE: SABIC® LDPE2102X0: commercially available low density polyethylene grade, having a melt flow index of 1.9 dg/min as determined at 190° C. and 2.16 kg according to ISO 1133:2011 and having a density of 921 kg/m³ as determined according to ISO1183-1:2012 at 23° C.
LDPE: SABIC® LDPE2004CX3: commercially available low density polyethylene grade, having a melt flow index of 4.6 dg/min as determined at 190° C. and 2.16 kg according to ISO 1133:2011 and having a density of 921 kg/m³ as determined according to ISO1183-1:2012 at 23° C.

### Preparation of HECO 1 and HECO 2

Gas-phase polymerizations were performed in a set of two horizontal, cylindrical gas phase reactors in series to prepare the heterophasic propylene copolymers HECO 1 and HECO2. The homopolymer was formed in the first reactor (R1) and an ethylene-propylene copolymer rubber in the second one (R2) to prepare a heterophasic propylene copolymer. Both reactors were operated in a continuous way. The first reactor was equipped with an off-gas port for recycling reactor gas through a condenser and back through a recycle line to the nozzles in the reactor. In both reactors, a mixture of liquid propylene containing up to 30% propane was used as the quench liquid. A high activity procatalyst produced in accordance with example 1 of WO2015/091983 (hereby incorporated by reference) was introduced into the first reactor as a slurry in mineral oil. Diisopropyl-dimethoxysilane (DiPDMS) was used as external donor and triethylaluminium (TEAL) was used as co-catalyst. The external donor and co-catalyst were fed at an Al/Ti ratio of 120 and a Si/Ti ratio of 12 to the first reactor. During operation, polypropylene powder produced in the first reactor was discharged through a powder discharge system into the second reactor. The polymer bed in each reactor was agitated by paddles attached to a longitudinal shaft within the reactor. Hydrogen was fed independently to both reactors to control a melt flow index ratio over the homopolymer powder and copolymer powder. In this respect, RCC2 is the amount of ethylene incorporated in the rubber fraction (wt %) and RC is the amount of rubber incorporated in the impact copolymer (wt %) determined by ¹³C-NMR spectroscopy.

TABLE 1
Reaction conditions and properties of
the heterophasic propylene copolymers.

| Value | unit | HECO 1 | HECO 2 |
|---|---|---|---|
| R1 | | | |
| T | ° C. | 60-74 | 60-74 |
| P | MPa | 23 | 23 |
| H2/C3 | (mol/mol) | 0.033 | 0.0049 |
| Al/Ti | (mol/mol) | 120 | 120 |
| Si/Ti | (mol/mol) | 12 | 12 |
| MFR_{PP} | (dg/min) | 50 | 84 |
| Isotacticity (pentad) | w % | 96.7 | 97.5 |
| R2 | | | |
| T | ° C. | 63 | 63 |
| P | MPa | 24.5 | 24 |
| H2/C3 | (mol/mol) | 0.023 | 0.0167 |
| C2/C3 | (mol/mol) | 0.415 | 0.33 |
| MFI_{heterophasic} | (dg/min) | 19 | 44 |
| RC | (wt %) | 22.5 | 12.8 |
| RCC2 | (wt %) | 52.6 | 47.8 |
| TC2 | (wt %) | 11.8 | 6.0 |
| CXS | wt % | 21.2 | 12.5 |
| IV CXS | dl/g | 3.34 | 2.5 |
| Mw/Mn | (—) | 5.8 | 5.9 |

Si/Ti is the ratio of the external donor (DiPDMS) to the procatalyst
Al/Si is the ratio of the co-catalyst (TEAL) to the external donor (DiPDMS)
H2/C3 is the molar ratio of hydrogen to propylene.

The compositions of examples (CE1, E1, E2, E3) were prepared by extruding the HECO 1 powder in a twin screw ZE21 extruder at 4 kg/hour with LDPE and 4500 ppm of basic stabilization additives and 0.17 wt % Luperox 802PP40) and as α-nucleating agents 0.5 w % talcum and 250 ppm Hyperform® HPN20E according to the formulation in Table 2.

The compositions of examples (CE2, E4) were prepared by extruding the HECO 1 powder in a twin screw CMP362 extruder at 40 ton/hour with LDPE and 2500 ppm of basic stabilization additives and as α-nucleating agents 0.5 w % talcum and 250 ppm Hyperform® HPN20E from Milliken and 0.1 w % Luperox 101M050 according to the formulation in Table 3.

The compositions of examples (CE3, CE4, CE5, E5, E6, E7) were prepared by extruding the HECO 2 powder in a twin screw ZE40 extruder at 50 kg/hour with the 0.5 w % talcum, LDPE and 3500 ppm of basic stabilization additives and as α-nucleating agents 0.5 w % talcum and 250 ppm Hyperform® HPN20E from Milliken and 0.05 w % Luperox 802PP40 according to the formulation in Table 4.

TABLE 2
Formulation and properties of E1, E2, E3 and CE1

| | | CE1 | E1 | E2 | E3 |
|---|---|---|---|---|---|
| Base powder 19IG (HECO 1) | % | 98.86 | 93.86 | 93.86 | 93.86 |
| LDPE 2004CX3 | % | | | | 5 |
| LDPE 2102X0 | % | | | 5 | |
| LDPE 2201H0 | % | | 5 | | |
| Talcum HM04 | % | 0.5 | 0.5 | 0.5 | 0.5 |
| Stabilization additives | % | 0.45 | 0.45 | 0.45 | 0.45 |
| HPN20 | % | 0.025 | 0.025 | 0.025 | 0.025 |
| PP-40 (Luperox 802PP40) | % | 0.17 | 0.17 | 0.17 | 0.17 |
| MFI LDPE 230 | g/10 min | NA | 1.94 | 4.8 | 11.9 |
| MFI LDPE 190 | g/10 min | NA | 0.85 | 1.9 | 4.6 |
| Density LDPE | kg/m³ | NA | 922 | 921 | 921 |
| MFI | g/10 min | 71.3 | 61.2 | 61 | 62.2 |
| Izod impact −20 | kJ/m² | 3.8 | 5 | 4.7 | 4.6 |
| Izod impact 0 | kJ/m² | 3.8 | 5.4 | 5.2 | 5 |
| Izod impact 23 C. | kJ/m² | 5.26 | 6.92 | 6.93 | 6.4 |
| Flexural modulus | N/mm² | 1343 | 1199 | 1222 | 1207 |
| MFRₜₒₜₐₗ/MFR_{LDPE 190} | (—) | NA | 32.2 | 12.7 | 5.2 |
| MFRₜₒₜₐₗ/MFR_{LDPE 230} | (—) | NA | 72.0 | 32.1 | 13.5 |

NA: not applicable

TABLE 3
Formulation and properties of E4 and CE2

| | | CE2 | E4 |
|---|---|---|---|
| Base powder 19IG (HECO 1) | % | 94.13 | 94.13 |
| LDPE 2100N0 | % | 5 | |
| LDPE 2201H0 | % | | 5 |
| Talcum HM04 | % | 0.5 | 0.5 |
| Stabilization additives | % | 0.25 | 0.25 |
| HPN20 | % | 0.025 | 0.025 |
| Luperox 101M050 | % | 0.1 | 0.1 |
| MFI LDPE 230 | g/10 min | 0.4 | 1.9 |
| MFI LDPE 190 | g/10 min | 0.33 | 0.85 |
| density LDPE | kg/m³ | 921 | 922 |
| MFI | g/10 min | 56.7 | 62 |
| Izod impact −20 | kJ/m² | 5.3 | 5.9 |
| Izod impact 0 | kJ/m² | 6.4 | 7 |
| Izod impact 23 C. | kJ/m² | 8.3 | 9.1 |
| Flexural modulus | N/mm² | 1236 | 1220 |
| MFRₜₒₜₐₗ/MFR_{LDPE 190} | (—) | 141.8 | 72.9 |
| MFRₜₒₜₐₗ/MFR_{LDPE 230} | (—) | 171.8 | 32.6 |
| gel 100μ | count | 4211 | 12.2 |
| gel 200μ | count | 1239 | 3.8 |
| gel 300μ | count | 308 | 1.1 |
| gel 400μ | count | 78 | 0.6 |
| gel 500μ | count | 26.2 | 0.3 |
| gel 600μ | count | 9.4 | 0.2 |
| gel 700μ | count | 4.5 | 0.1 |
| gel 800μ | count | 1.8 | 0 |
| gel 900μ | count | 0.6 | 0 |
| gel 1000μ | count | 0.2 | 0 |
| max agglomerate size (μm) | μm | 70 | |

TABLE 4
Formulation and properties of examples E5, E6, E7, CE3, CE4 and CE5

| | | CE3 | CE4 | CE5 | E5 | E6 | E7 |
|---|---|---|---|---|---|---|---|
| Base powder 43IG (HECO2) | % | 99.11 | 94.11 | 94.11 | 94.11 | 94.11 | 94.11 |
| LDPE 2004CX3 | % | | | | | | 5 |
| LDPE 2100N0 | % | | 5 | | | | |
| LDPE 2102X0 | % | | | | | 5 | |
| LDPE 2200H0 | % | | | 5 | | | |
| LDPE 2201H0 | % | | | | 5 | | |
| Talcum HM04 | % | 0.5 | 0.5 | 0.5 | 0.5 | 0.5 | 0.5 |
| Stabilization additives | % | 0.35 | 0.35 | 0.35 | 0.35 | 0.35 | 0.35 |
| HPN20 | % | 0.025 | 0.025 | 0.025 | 0.025 | 0.025 | 0.025 |
| PP-40 (Luperox 802PP40) | % | 0.02 | 0.02 | 0.02 | 0.02 | 0.02 | 0.02 |
| MFI LDPE 230 | g/10 min | NA | 0.4 | 0.6 | 1.9 | 4.8 | 11.9 |
| MFI LDPE 190 | g/10 min | NA | 0.33 | 0.33 | 0.85 | 1.9 | 4.6 |
| density LDPE | kg/m³ | NA | 921 | 922 | 922 | 921 | 921 |
| MFI | g/10 min | 64.1 | 52.1 | 52.9 | 55.4 | 53.1 | 52.9 |
| Izod impact −20 | kJ/m² | 3.43 | 3.55 | 3.39 | 3.77 | 3.85 | 3.59 |
| Izod impact 0 | kJ/m² | 3.9 | 4.23 | 3.73 | 4.62 | 4.74 | 4.07 |
| Izod impact 23 C. | kJ/m² | 5.4 | 6 | 5.7 | 6.7 | 6.9 | 6.4 |
| Flexural modulus | N/mm² | 1569 | 1476 | 1474 | 1450 | 1471 | 1466 |
| MFRₜₒₜₐₗ/MFR_{LDPE 190} | (—) | NA | 130.3 | 88.2 | 29.2 | 11.1 | 4.4 |
| MFRₜₒₜₐₗ/MFR_{LDPE 230} | (—) | NA | 157.9 | 160.3 | 65.2 | 27.9 | 11.5 |
| gel 100μ | count | 1564 | 43463 | 68021 | 750.1 | 255.3 | 585.7 |
| gel 200μ | count | 117.5 | 13506 | 23195 | 146.8 | 49.6 | 87.8 |
| gel 300μ | count | 25 | 5033.8 | 9299 | 40 | 14.3 | 26.6 |
| gel 400μ | count | 6.4 | 1908.8 | 4051 | 9.6 | 2.7 | 9.9 |
| gel 500μ | count | 3 | 758.6 | 1766 | 2.4 | 0.5 | 4.9 |
| gel 600μ | count | 0.9 | 354.5 | 876 | 1 | 0.1 | 3.9 |
| gel 700μ | count | 0.4 | 191.8 | 493 | 0.5 | 0.1 | 3.4 |
| gel 800μ | count | 0.4 | 120.2 | 315.4 | 0.5 | 0.1 | 3 |
| gel 900μ | count | 0.4 | 87 | 218.6 | 0.2 | 0.1 | 2.6 |
| gel 1000μ | count | 0.3 | 66.1 | 163 | 0.2 | 0 | 2.3 |
| max agglomerate size (μm) | μm | 0 | 128 | 109 | 43 | 0 | 0 |

NA: not applicable

### CONCLUSION

As can be seen from the above Tables, polypropylene compositions according to the invention, wherein the polypropylene composition satisfies the following inequation:

$$0.9 < {MFR}_{total} / {MFR}_{LDPE , 230} < 150$$

show improved impact properties at low temperature as well as at room temperature, while maintaining the stiffness (flexural modulus) and processability (same flow).

This makes the polypropylene composition of the invention very suitable for use in injection molding process and/or very suitable for the preparation of packaging articles, such as food packaging articles in which it is very important that such articles are able to withstand mechanical impact damage, such as dropping of the articles, for example for chilled and frozen food packaging (e.g. icecream tubs). In addition, such polypropylene compositions—due to the desired properties—are also very suitable for the preparation of thin(ner) wall articles, which is important as it enables the reduction of the carbon footprint of such articles.

Additionally, the polypropylene compositions of the invention allow for the production of injection molded articles having a lower max. agglomerate size (μm).

1. Polypropylene composition comprising
a heterophasic propylene copolymer (A) in an amount of at least 85 wt % based on the polypropylene composition
a low density polyethylene (B) in an amount from 1.0 to 7.0 wt % based on the polypropylene composition
and an α-nucleating agent (C) in an amount from 0.001 to 1.5 wt % based on the polypropylene composition
wherein the heterophasic propylene copolymer (A) comprises
(a) a propylene homopolymer matrix in an amount from 75 to 90 wt % based on the heterophasic propylene copolymer and
(b) an ethylene-propylene copolymer in an amount from 10 to 25 wt % based on the heterophasic propylene copolymer and wherein the ethylene-propylene copolymer comprises 43 to 57 wt % of units derived from ethylene and
wherein the low density polyethylene (B) has a melt flow rate (MFR_{LDPE, 230}) as determined according to ISO1133:2011 using 2.16 kg at 230° C.
and wherein the low density polyethylene (B) has a density in the range from 915 to 932 kg/m³ as measured according to ISO1183-1:2012
wherein the polypropylene composition has a total melt flow rate (MFRₜₒₜₐₗ) in the range from 30 to 150 dg/min, wherein the total melt flow rate is determined using ISO1133:2011 using 2.16 kg at 230° C.,
wherein the polypropylene composition satisfies the following inequation:
$$0.9 < {MFR}_{total} / {MFR}_{LDPE , 230} < 150.$$

2. Polypropylene composition according to claim 1, wherein the low density polyethylene (B)
i) has a melt flow rate (MFR_{LDPE, 230}) as determined according to ISO1133:2011 using 2.16 kg at 230° C. in the range from 0.30 to 20 dg/min and/or
ii) has a density in the range from 915 to 928, as measured according to ISO1183-1:2012.

3. Polypropylene composition according to claim 1, wherein the low density polyethylene (B) has a melt flow rate as determined according to ISO1133:2011 using 2.16 kg at 190° C. (MFR_{LDPE, 190}) in the range from 0.10 to 5.0 dg/min.

4. Polypropylene composition according to claim 1, wherein the polypropylene composition satisfies the following inequation:
$$1. < {MFR}_{total} / {MFR}_{LDPE , 190} < 95.$$

5. Polypropylene composition according to claim 1, wherein the heterophasic propylene copolymer
i) has a melt flow rate (MFR_{HECO}) as determined according to ISO1133:2011 using 2.16 kg at 230° C. in the range from 1.0 to 150 dg/min, and/or
ii) has a total ethylene content in the range from 3.0 to 15 wt %, based on the heterophasic propylene copolymer and/or
iii) has an Mw/Mn in the range from 3.0 to 11.0, wherein Mw stands for the weight average molecular weight and Mn stands for the number average weight and wherein Mw and Mn are measured according to ISO16014-1(4):2003.

6. Polypropylene composition according to claim 1, wherein the propylene homopolymer matrix
i) has a pentad isotacticity of at least 95 wt. %, wherein the pentad isotacticity is determined using ¹³C NMR and/or
ii) has a melt flow rate (MFR_{PP}) as determined according to ISO1133:2011 using 2.16 kg at 230° C. in the range from 35 to 150 dg/min, and/or
iii) has an Mw/Mn in the range from 3.0 to 11.0, wherein Mw stands for the weight average molecular weight and Mn stands for the number average weight and wherein Mw and Mn are measured according to ISO16014-1(4):2003.

7. Polypropylene composition according to claim 1, wherein
i) the heterophasic propylene copolymer comprises the ethylene-propylene copolymer in an amount of 10 to 15 wt % based on the heterophasic propylene copolymer and the ethylene-propylene copolymer comprises 43 to 51 wt % of units derived from ethylene or
ii) the heterophasic propylene copolymer comprises the ethylene-propylene copolymer in an amount of 20 to 25 wt % based on the heterophasic propylene copolymer and the ethylene-propylene copolymer comprises 52 to 57 wt % of units derived from ethylene.

8. Polypropylene composition according to claim 1, wherein the heterophasic propylene copolymer is produced in a sequential multi-reactor polymerization process in the presence of
a) a Ziegler-Natta catalyst comprising compounds of a transition metal of Group 4 to 6 of IUPAC, a Group 2 metal compound and an internal donor,
b) a co-catalyst (Co), and
c) optionally an external donor.

9. Polypropylene composition according to claim 1, wherein the heterophasic propylene copolymer is prepared by visbreaking an intermediate heterophasic propylene copolymer prepared in a sequential multi-reactor polymerization process and having an initial melt flow rate (MFRᵢ) as determined according to ISO1133:2011 using 2.16 kg at 230° C. by contacting said intermediate heterophasic propylene copolymer in a melt mixing process with a peroxide to form the heterophasic propylene copolymer having a melt flow rate (MFR_{HECO}) as determined according to ISO1133:2011 using 2.16 kg at 230° C. with a visbreaking ratio MFR_{HECO}/MFRᵢ in the range from 1.2 to 10.

10. Polypropylene composition according to claim 1, wherein the α-nucleating agent is selected from the group consisting of (i) salts of monocarboxylic acids and polycarboxylic acids, (ii) sorbitol or nonitol derivatives, benzenetrisamides, (iii) salts of diesters of phosphoric acid, (iv) polymeric nucleating agents and (v) talcums and/or
wherein the α-nucleating agent is present in an amount from 0.10 to 1.2 wt % based on the polypropylene composition.

11. Polypropylene composition according to claim 1, wherein the polypropylene composition further comprises additives (D).

12. Polypropylene composition according to claim 1, wherein the polypropylene composition when injection molded into a 3.2 mm thick specimen prepared according to ISO37/2 shows a maximal agglomerate size of ≤50 μm.

13. Article comprising the polypropylene composition according to claim 1.

14. (canceled)

15. Process for the preparation of an article comprising the steps of
a) providing the polypropylene composition of claim 1 and
b) converting the polypropylene composition into an article.

16. (canceled)

17. The article of claim 13, wherein the amount of the polypropylene composition is at least 95 wt % based on the article.

18. The article of claim 13, wherein the article is a packaging article.
